(19) United States
(12) Patent Application Publication
(10) Pub. No.: US 2026/0121953 A1
(43) Pub. Date: Apr. 30, 2026

(54) UTILIZATION OF CONTEXTUAL METADATA FOR IDENTIFYING NETWORK OPERATIONAL DATA TELEMETRY AND EVENTS

(71) Applicant: Cisco Technology, Inc., San Jose, CA (US)

(72) Inventors: John J Mullooly, Colts Neck, NJ (US); David John Smith, Scotch Plains, NJ (US); Viktor Mats Emanuel Leijon, San Jose, CA (US); Marty David Fierbaugh, Wake Forest, NC (US); Zafar Ali, Hicksville, NY (US)

(21) Appl. No.: 18/930,091

(22) Filed: Oct. 29, 2024

(51) Int. Cl. H04L 43/065; H04L 43/0829; H04L 43/0888

(52) U.S. Cl. CPC H04L 43/065; H04L 43/0829; H04L 43/0888

(57) ABSTRACT

Techniques and mechanisms for utilization of contextual metadata for identifying network operation telemetry and events are provided. Contextual metadata is applied to router resource objects associated with network resources operating via network routers to and from user computing devices or systems. Telemetry data associated with operation of the network resources is streamed to a telemetry collector. Event logs including the contextual metadata may be stored locally with the user's devices or systems for viewing or may be sent remotely to a remote syslog server. At the telemetry collector or the syslog server, the contextual metadata is used to separate telemetry data and/or event logs on network resource identity basis so that operation of the network resources may be analyzed and reported.

### TECHNICAL FIELD

The present disclosure relates generally to collection and use of telemetry and event logs from network systems. More particularly, techniques and mechanisms of the present disclosure relate to configuration of Internet Protocol (IP) router resource objects with contextual metadata for identifying network resource identity-specific telemetry and event logs from a network telemetry feed or event logging function.

### BACKGROUND

Computing systems and communications systems networks are utilized by a wide range of users from individual users to large multi-national organizations. A typical user whether an individual user or organization of varying sizes may generate, utilize, and transport data from a variety of computing systems across one or more communications networks to a variety of intermediary or endpoint systems or recipients. For example, an individual user or small business may operate on-premises computing systems that provide services such as data processing, electronic mail, business management systems, equipment automation systems, and the like. Data from such systems may be transported locally among users' computing systems (e.g., electronic mail from a laptop computer to an electronic mail server or processing data from equipment automation systems to a central quality control application, and the like). Large organizations, for example, large businesses, social networking systems, education systems, and the like may transport data locally among local area networks or across complex wide area networks (e.g., data from multiple locations of a large business to a central data processing hub).

Users from single users to large organizations having hundreds or thousands of individual computing systems stations/users typically engage a services provider, for example, a telecommunications services provider or Internet services provider to provide local and/or wide area data transport services. In a typical services provider engagement, users demand various data transport outcomes, for example, data transport speeds, data transport latency, data transport bandwidth, data packet loss levels, data throughput, data transport security information, and the like. In order to ensure services requested by a given user are being operated according to a service level agreement (SLA) between the user and the services provider, the services provider may analyze the efficacy of services being provided to the user so that any aspects of the services being provided (e.g., data throughput and data transport latency) either meet agreed-upon service levels or that are corrected if any such aspects of provided services are not operating according to the SLA.

Because various networking systems enabled by services providers may be utilized for large numbers of disparate users, telemetry data or event logs streamed from network services will include data transport operating information associated with many different users. The ability of the services provider to separate data transport information for one user from data transport information for another user becomes very difficult. For example, if two users (e.g., two businesses) receive data transport services through a given network enabled by a given services provider, telemetry feed or event logs for components of the network (e.g., network routers or switches) may be collected for analysis of operating efficacy of the components and associated router resource objects. For example, if the first example user has contracted with the services provider for specified levels of data transport speed, data transport latency, data transport bandwidth, data packet loss, and the like while a second user has contracted with the services provider for different levels of data transport speed, data transport latency, packet loss, and the like, the services provider needs to separate telemetry or event data for the first user from telemetry or event data for the second user in order to analyze the data and ensure both users are receiving agreed-upon services levels. Unfortunately, telemetry or event data from a router through which both users receive data transport services contains non-contextualized data for all users receiving data transport services through that router. Thus, it becomes difficult and computationally expensive to determine the data transport efficacy of network systems for each user independently of other users.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture for applying contextual metadata to router resource objects in a data network for identifying telemetry and event logs on a resource identity basis from a telemetry feed or events log.

FIG. 2 illustrates a system architecture for applying contextual metadata to router resource objects in a sliced data network for identifying telemetry and event logs on a resource identity basis from a telemetry feed or events log.

FIG. 3 illustrates a pair of example metadata tagging programming formats for configuration of example router resource objects associated with one or more network resources as described herein.

FIG. 4 illustrates a flow diagram of an example method for configuring a router resource object with metadata that may be used for identifying telemetry and/or event logs associated with a particular network resource identity.

FIG. 5 illustrates a flow diagram of an example method for identifying network resource identity-specific telemetry and/or event logs from a network telemetry feed.

FIG. 6 illustrates a flow diagram of an example method for identifying network resource identity-specific telemetry and/or event logs from a network telemetry feed.

FIG. 7 is a computer architecture diagram showing an illustrative computer hardware architecture for implementing a computing system/device that can be utilized to implement aspects of the various technologies presented herein.

### DESCRIPTION OF EXAMPLE EMBODIMENTS

### Overview

The present disclosure relates generally to collection and use of telemetry and event logs from network systems. More particularly, techniques and mechanisms of the present disclosure relate to configuration of Internet Protocol (IP) router resource objects with contextual metadata for identifying network resource identity-specific telemetry and event logs from a network telemetry feed or event logging function.

According to examples, network routers may be provisioned with a variety of router resource objects associated with network resources provided in association with computing and communications systems in a given network, across a network and/or from one network to another network. Network resources may be associated with one or more network resource identities including but not limited to particular users, user locations, network services, network services locations, network routing protocols, network security protocols, Internet Protocol (IP) addresses associated with network resources, communications interfaces, network slices, and the like.

According to examples of the present disclosure, router resource objects of a network router may be provisioned with metadata associated with various network resources. During network operations, the network router may generate telemetry data for each of the various network resources operating via the network router. The telemetry data may identify one or more network resources identities associated with a given network resource for which a telemetry feed is generated. For example, for a network security service operated for a given user, a telemetry feed from the router may provide operational data about the performance of the example network security service, and metadata provisioned on the router in association with the example network security service may identify the given user. Thus, performance of the example network security service may be analyzed and reported for the given user separate from many other users that may utilize the example security service via the router. That is, by provisioning metadata on the router resource objects of a network router associated with various network resources, telemetry data may be generated on a network resource identity basis. For example, operational data for a given network resource may be reported based on any desired network resource identity such as user identity, location identity, service identity, etc. as set out above. Knowing operational data associated with a given network resource identity (e.g., a user) allows for management of network resources in association with the network resource identity (e.g., assuring service level agreements for the example user).

According to another example, provisioning of metadata on the router resource objects of the network router associated with various network resources allows events associated with the network resources to be stored as event logs on a network resource identity basis for analysis, reporting, and possible corrective action. For example, if a communications interface operated via the router fails, an alarm or notification for the failure may be stored as an event log for analysis, reporting, and possible corrective action. If metadata identifying a user or other network resource identity associated with the failing communications interface is provisioned on the router, then an event log associated with the failing communication may be generated, and the metadata associated with the user or other network resource identity in association with the failing communications interface allows for the event to be managed in association with the user or other network resource identity. That is, knowing event data associated with a given network resource identity (e.g., a user) allows for management of network resources in association with the network resource identity (e.g., assuring service level agreements for the example user).

A method to perform techniques described herein may include provisioning a router resource object, the router resource object associated with a network resource. The router resource object may be provisioned with contextual metadata, the contextual metadata identifying a network resource identity associated with the network resource. The network resource identity may include but limited to particular users, user locations, network services, network services locations, network routing protocols, network security protocols, Internet Protocol (IP) addresses associated with network resources, communications interfaces, network slices, and the like.

Telemetry and/or event logs are generated for the network resource including the contextual metadata and one or more attributes of the network resource, and any of the one or more attributes of the network resource associated with the network resource identity identified in the contextual metadata are extracted from the telemetry or log event. The one or more attributes of the network resource may include one or more of data transport speeds, data transport latency, data transport bandwidth, data packet loss levels, data throughput, data transport security information, and the like.

The one or more attributes of the network resource in association with the user identified in the contextual metadata may be stored. The stored one or more attributes of the network resource may be aggregated with one or more attributes of one or more other network resources associated with the user identified in the contextual metadata. If the contextual metadata identifies one or more other users associated with the network resource, the one or more attributes of the network resource in association with the one or more other users associated with the network resource is stored separately from storing the one or more attributes of the network resource in association with the user identified in the contextual metadata.

The stored one or more attributes of the network resource may be passed to an analytics engine for analysis to determine, among other things, whether the one or more attributes of the network resource meet user-defined network requirements. The stored one or more attributes of the network resource also may be passed to an artificial intelligence/machine learning model to teach the model for future query processing associated with network resource operation. In addition, the stored one or more attributes of the network resource also may be passed to the user of the network resource and/or to a services provider of the network in which the network resource operates.

A further method to perform the techniques described herein may include partitioning a network into a plurality of network slices. A router resource object may be provisioned on a network router in association with one of the plurality of network slices, the router resource object operable to communicate via the network router with one or more network resources. The router resource object may be provisioned with contextual metadata, the contextual metadata identifying the one of the plurality of network slices and a user associated with the one of the plurality of network slices. Provisioning the router resource object with contextual metadata also may include provisioning the router resource object with contextual metadata identifying other network resource identities associated with the router resource object. A telemetry feed may be generated from the network router for the network resource including the contextual metadata and one or more attributes of the network resource. An event log may be generated from the network router for the network resource including the contextual metadata and one or more attributes of the network resource.

The telemetry feed and/or event logs may be routed to a telemetry collector and/or syslog, respectively, and at the telemetry collector and/or syslog, any of the one or more attributes of the network resource associated with the one of the plurality of network slices and the user associated with the one of the plurality of network slices identified in the contextual metadata may be extracted from the telemetry feed and/or event logs. The one or more attributes of the network resource in association with the one of the plurality of network slices and the user associated with the one of the plurality of network slices identified in the contextual metadata may be stored. The stored one or more attributes of the network resource may be aggregated with one or more attributes of one or more other network resources associated with the one of the plurality of network slices and the user associated with the one of the plurality of network slices identified in the contextual metadata. Storing the one or more attributes of the network resource also may include storing the one or more attributes of the network communications in association with the location identified in the contextual metadata.

Additionally, the techniques described herein may be performed by a network component (e.g., a network router) having non-transitory computer-readable media storing computer-executable instructions that, when executed by one or more processors, performs the methods described above.

### Example Embodiments

As briefly discussed above, computing systems and communications systems networks are utilized by a wide range of users. Local, wide area, on-premises and cloud-based networks are used for a great variety of computing and communications services. For example, users ranging from individual users to small businesses to large multi-national organizations use networking systems for communications, data entry and data processing for a wide range of services. Networking may be enabled by a networking service, for example, a telecommunications services provider, Internet services provider, and the like. Networks provided by such services providers may be configured in a number of ways. For example, a network may be configured that hosts a single user or a network may be configured that hosts a number of users. In the latter case, a network may be comprised of a number of computing and communications systems that are connected via one or more switches and routers that ensure data is transported to and from the various computing systems and communications systems on behalf of the user. For example, a given user may be associated with electronic mail systems, databases, security systems, and the like.

In addition to such networking systems where a user's computing and/or communications systems are operated via a dedicated network or as part of a network that hosts a number of users, users' networking needs may also be hosted according to a network slicing configuration. According to a network slicing configuration, a single network is “sliced” or partitioned virtually, and each user is assigned to networking services via a slice or partition of the network. That is, a virtual instantiation of a physical network is provided for each user so that each user receives dedicated networking functionality via the assigned network slice or partition as if the entire network is dedicated only and wholly to the user.

In either case where multiple users receive services via a single network or where multiple users receive services via virtual network slices, there is a need to collect, review, and utilize network operating data associated with individual users to ensure that services provision for users meet service level requirements for those users. For example, if a given user has a service level agreement (SLA) with a services provider for data transport, for example, data transport speeds, data transport latency, data transport bandwidth, data packet loss levels, data throughput, data transport security information, and the like, there is a need to collect data on behalf of the user that can be analyzed for ensuring the service level agreement between the user and the services provider is being met. Unfortunately, because data streamed from network components, such as a network router, may include data for tens, hundreds, thousands or more users, separating network operating data for individual users becomes computationally difficult and expensive.

According to examples of the present disclosure, the techniques and mechanisms described herein provide for metadata tagging of router resource objects of a network router, where a network device operating system (e.g., a network router operating system) is provisioned with and automatically adds these metadata tags into an object level streaming telemetry feed or event log from the network device (e.g., network router). The metadata tags included in the telemetry feed or event log allow network operating information to be separated on a network resource identity including but not limited to particular users, user locations, network services, network services locations, network routing protocols, network security protocols, Internet Protocol (IP) addresses associated with network resources, communications interfaces, network slices, and the like. That is, as should be appreciated, network operating information may be tagged based on any identifying information designated by an administrator or requesting user of a given network resource. According to examples, the metadata tagging format may include a simple user-defined “key-value-pair” (i.e., key: [value1, value2]) where the value field may include a single string or a list of string values that may be used to identify a user, location, user location, user network slice, or the like in association with network operating information included in the telemetry feed or event log.

By using network resource identity-specific metadata tags in the device-level configuration of router resource objects, programmed consistently across all the devices that are part of the same network or network slice, configured via a programable network orchestrator controller or network slicing orchestrator controller, the devices may export telemetry or event log data with beneficial contextual data to a telemetry collector or event log server (e.g., a system log or syslog server) for analytics, artificial intelligence/machine learning (AI/ML) model training, and reporting. In addition, network controllers and other systems may then search via XPath filters on the metadata fields, across multiple devices, to find relevant configuration details that match specific user contexts. According to examples, the metadata keys and values are strings that are user defined. There is no need for the device operating system to be hard coded to support specific keys. The telemetry collector can process the streaming telemetry with appropriate contextual information to verify that the proper network or network slice resources are behaving within the SLA agreed upon between the user and an associated network services provider. In addition, predictive AI/ML training may be enhanced with information extracted from the event log or telemetry feed based on the user defined metadata.

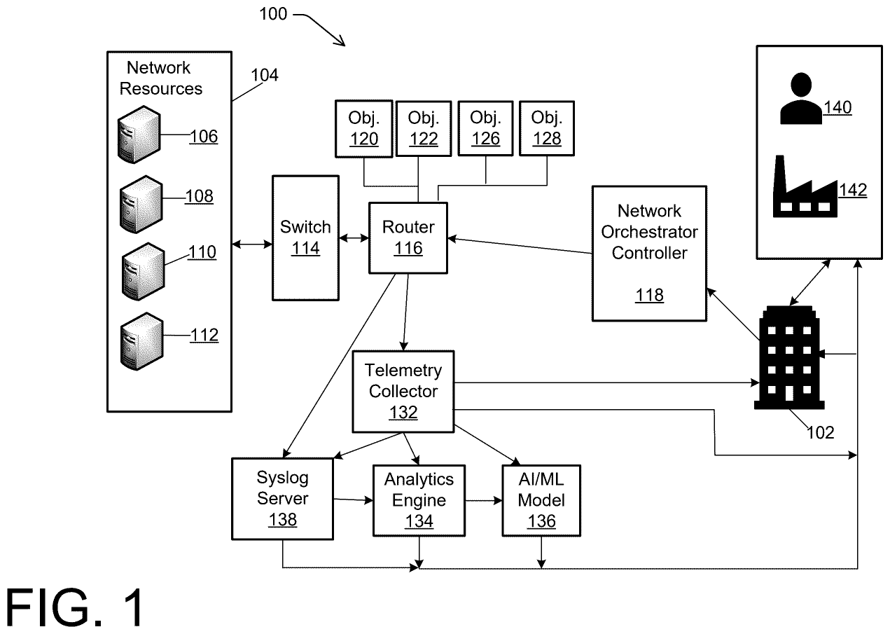

FIG. 1 illustrates a system architecture for applying contextual metadata to router resource objects in a data network for identifying telemetry and event logs on a resource identity basis from a telemetry feed or events log. According to examples, the network 100 is illustrative of an on-premises or cloud-based system with which computing services and communication services may be provided to one or more users 140, 142, as described herein. The users 140, 142 are representative of one or more users for which network services of the network 100 may be provided by a services provider 102, for example, a telecommunications or Internet services provider. For example, the user 140 may represent one or more individual users, and the user 142 may represent one or more user entities such as businesses or other organizations of varying sizes from small organizations to large multi-national organizations. As should be appreciated, tens, hundreds, thousands or more users 140, 142 may utilize services via the network 100, as described herein.

The network 100 is illustrative of a local area network that may operate in a user facility such as a home, place of business or campus of facilities. Alternatively, the network 100 may be illustrative of a wide area network where components of the network 100 are distributed across varying distances and where the components of the network 100 communicate with each other via a telecommunications or Internet services provider. The network 100 may be provided by a services provider, for example, a telecommunications services provider, an Internet services provider, or the like. According to examples, one or more computing devices or systems 104 may be provided on-premises or cloud-based with which a user 140, 142 may perform data processing and communications actions. The computing devices or systems 104 may include one or more computing devices or systems 106, 108, 110, 112 with which computing and/or communications actions may be accomplished by and/or for the user 140, 142. For example, the computing devices or systems 104-112 may include electronic mail servers, databases, data and communications security systems, equipment control systems, and the like. The computing devices or systems 104-112 may also include peripheral devices such as printers, wireless access points, personal computing devices, and the like that are connected and operable via the network 100.

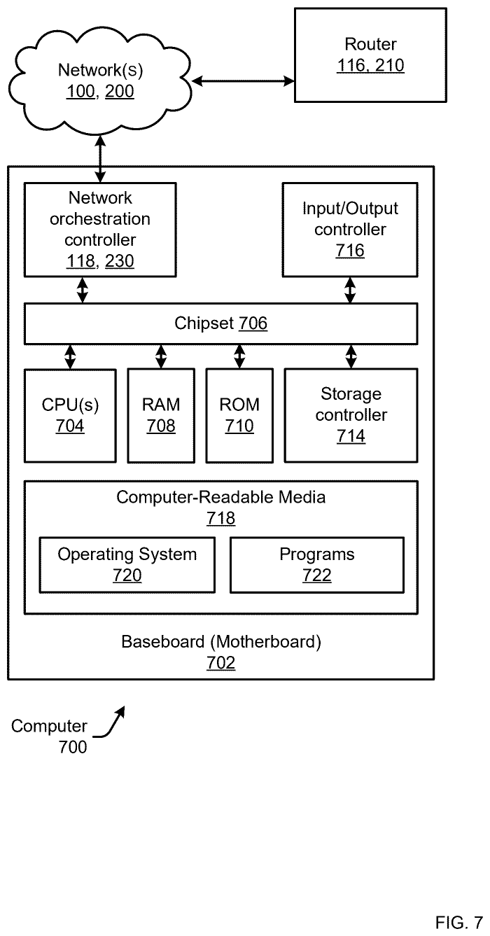

Each of the computing devices or systems 104-112 may be separate physical devices, each of the computing devices or systems 104-112 may be combined and may operate as a single computing device. Components and attributes of computing devices or systems 104-112 are described below with reference to FIG. 7. Alternatively, one or more of the computing devices or systems 104-112 may be configured as virtual computing systems operated via one or more physical computing devices or systems 104-112. In such a configuration, each virtual computing system may provide a type of functionality, for example, electronic mail services, database services, or the like as a virtual system in the same manner as each of such systems may be provided via a dedicated physical system or device such as an electronic mail or database server.

Referring still to FIG. 1, the switch 114 is illustrative of a device or application responsible for connecting network devices such as the computing devices or systems 104-112 to each other or to other systems within the network 100 or two computing systems or devices outside the network 100 other networks 100. The router 116 is illustrative of a device or application that connects different computing systems and devices to allow those systems and devices to communicate with other computing systems from one location to another across a telecommunications system or the Internet. According to examples, the router 116 may include at least one processor, as illustrated and described below with reference to FIG. 7, for executing programming instructions provisioned on the router 116, as described herein. The router 116 may connect computing systems and devices to create local networks of systems and devices that may operate in a single location (e.g., a home, building or facility), or the router may connect computing systems and devices to create large networks 100 that may operate across locations (e.g., from one city to another city). According to examples, the systems, methods described herein operating via the router 116 may be operated via the switch 114 or similar network device or system. According to one example, the functionality of the router 116 and the switch 114 may operate via a single network device that includes the functionality of both the switch 114 and the router 116.

According to examples of the present disclosure, the router 116 may enable a number of network resources in association with a user's computing devices or systems 104-112. Network resources enabled by the router 116 may be associated with one or more network resource identities including but not limited to particular users, user locations, network services, network services locations, network routing protocols, network security protocols, Internet Protocol (IP) addresses associated with network resources, communications interfaces, communications interfaces, network slices, and the like. As understood by those skilled in the art, network resources may include one or more interfaces with which a user's computing devices or systems 104-112 communicate with each other and across the network 100. Network resources may also include a number of other resources including but not limited to software-enabled systems associated with the user's computing devices and systems 104-112 such as data security systems, data throughput monitoring systems, and the like.

Examples of network resources include but are not limited to one or more wired, wireless and software-defined interfaces that may be provisioned on routers 116 and that may be employed to direct how data traffic will flow from the user's computing devices or systems 104-112 through the router 116 and out to other computing systems or devices. With such interfaces, routing of communications from one router 116 to another router 116 may be directed. For example, a user 140, 142 may employ a virtual private network (VPN) for providing encrypted communications to and from the user's computing devices or systems 104-112 across a network 100 to and from other users 140, 142 in other homes, facilities and locations via routers 116. Other network resources may include protocols that direct attributes of communications including data throughput, data security information, data quality of service (QoS), and the like.

Other examples of network resources may include customer facing provider-edge (PE) interfaces and provider-edge (PE) to customer-edge (CE) interfaces. Such interfaces may provide routing targets information, route descriptors, pseudo wire (PW) setups, VPN setups and management, virtual routing and forwarding (VRF) interfaces that provide for multiple routing configurations on a single router 116, and the like. Additional examples may include PE-CE peering protocols, QoS policies, segment routing traffic engineering (SR-TE) templates and policies, border gateway protocols (BGP) that provide for inter domain routing, network resource partitions (NRP), streaming telemetry paths, and the like. That is, as understood by those skilled in the art, a vast number of router resource objects may be provisioned on routers 116 for enabling user-required or user-defined network resources for setting up virtual networking systems, for directing how communications will be routed across a network and for monitoring performance of communications across a network. As should be appreciated, the foregoing example services and systems are for purposes of example only and are not limiting of other types of router resource objects and associated network resources that may be provisioned on the router 116.

As described below, by monitoring performance of network resources via router resource objects provisioned on routers 116 on a network resource identity basis, assurance of network performance may be provided as required for a given user, location or user-location combination. For example, if a given user 140, 142 requires data throughput for a virtual private network to user facilities and personnel, being able to monitor the performance of network resources in association with the given user 140, 142 apart from other users operating is essential. For example, by knowing network resource performance for a given user 140, 142, if data throughput for the user's example VPN system is below a required or agreed upon throughput for the given user, corrective action may be taken such as changing a routing path for the user's VPN traffic to improve data throughput.

Referring still to FIG. 1, a network orchestrator controller 118 is illustrative of a device or application that sets up or provisions network systems or devices such as the router 116 and switch 114 for processing and delivering requests and objectives of a requesting user 140, 142. For example, if a user 140, 142 requires data transport such as data from electronic mail services to be operated according to a desired data throughput (e.g., data transport speeds, data transport latency, data transport bandwidth, data packet loss levels, data throughput, data transport security information, and the like), the network orchestrator controller 118 may provision the router 116 with router resource objects that manage network resources including router resource objects (described above) responsible for the user's data services via the router 116.

According to examples of the present disclosure, the network orchestrator controller 118 provisions one or more router resource objects 120, 122, 126, 128 on the router 116. As described above, the one or more router resource objects 120, 122, 126, 128 may also be provisioned on a switch 114 for performing the functions of the router resource objects as described herein. Router resource objects 120, 122, 126, 128 may include programming code or applications responsible for communicating objectives or intent of the user 140, 142 with respect to data services associated with the computing devices or systems 104-112 via the router 116 and across the network 100. For example, if a user 140, 142 requires as an objective or intent that data throughput from the user's computing systems and devices 104-112 is processed through the router 116 and out to other networks 100 according to a given data throughput speed and acceptable packet loss level, the network orchestrator controller 118 may provision a router resource object 120 on the router 116 that will direct or control the data transport operation of data to and from the user's computing systems and devices 104-112 such that the user's required data throughput is enabled by the router 116.

According to examples of the present disclosure, one or more of the router resource objects 120-128 provisioned on the router 116 may be associated with one user 140, and one or more of the router resource objects 120-128 provisioned of the router 116 may be associated with another user 142. In addition, as described in further detail below, one or more of the router resource objects 120-128 provisioned on the router 116 may be associated with multiple users 140, 142. For example, following from the electronic mail server service example described above, a single router resource object 120 provisioned on the router 116 may be associated with provision of data transport for electronic mail communications for multiple users 140, 142. On the other hand, a router resource object 122 may be associated with a data security service for a user 140 while a different router resource object 126 may be associated with a data security service for a different user 142.

Referring still to FIG. 1, telemetry may be streamed from the router 116 for network resources provisioned on the router 116 in association with corresponding router resource objects 120-128 to a telemetry collector 132. According to examples, the telemetry streamed for each network resource associated with the router resource objects may include one or more attributes for which associated router resource objects are provisioned, including by not limited to data transport speeds, data transport latency, data transport bandwidth, data packet loss levels, data throughput, data transport security information, and the like. The telemetry collector 132 may include a physical computing device, as illustrated and described with reference to FIG. 7, virtual computing service, or application enabled to receive, separate and aggregate telemetry data from the router resource objects associated with corresponding network resources operated via the router 116. For example, if a router resource object 120 is provisioned on the router 116 associated with a network resource for virtual private network (VPN) operations, telemetry from the router 116 for the example VPN associated with the router resource object 120 may include data transport information (e.g., data transport speeds, data transport latency, data transport bandwidth, data packet loss levels, data throughput, data transport security information, etc.).

At the telemetry collector 132, telemetry data for each of the network resources for which the router resource objects 120-128 are provisioned may be separated and stored, as described herein. As will be described below, use of contextual metadata applied to the router resource objects in association with the network resources allows received telemetry data to be separated and aggregated by network resource identities including but not limited to particular users, user locations, network services, network services locations, network routing protocols, network security protocols, Internet Protocol (IP) addresses associated with network resources, communications interfaces, network slices, and the like. That is, as should be appreciated, network operating information for network resources may be tagged based on any identifying information designated by an administrator or requesting user of a given network resource. The separated and stored network resource identities-specific telemetry data may be aggregated for eventual analysis, reporting, and/or for training an artificial intelligence/machine learning model, as described below. That is, all telemetry data for a given user may be aggregated, all telemetry data for a given location may be aggregated, all telemetry data for a given service may be aggregated, and so on. As should be appreciated, telemetry data may be separated and aggregated based on any of the aforementioned network resource identities but may also be separated and aggregated based on combinations thereof. For example, telemetry may be separated based on a user, user location and service for a given service such as a data security service so that data showing performance of the example data security service for the given user at the given location for the data security service may be aggregated, analyzed and/or reported. Alternatively, if telemetry data for a plurality of network resources and associated router resource objects 120-128 are associated with a single user or other network resource identity, then telemetry associated with each of the router resource objects 120-128 associated with the single user or other network resource identity may be aggregated for subsequent use, as described herein. Once telemetry data for each network resource and associated router resource object is streamed to the telemetry collector 132, collected and aggregated data may be used to analyze performance of each of the network resources for which router resource objects are provisioned.

Referring still to FIG. 1, the collected and aggregated telemetry data may be passed to an analytics engine 134 for analysis. For example, aggregated data throughput information for an example VPN interface and associated router resource object 120 may be compared with desired throughput for the example VPN interface. If the actual throughput for the example VPN interface reported to the telemetry collector 132 via streaming telemetry is below the desired or required level according to a service level agreement for the user of the associated network resource (e.g., VPN interface), then that information may be reported to the user 140, 142 who/which may then take corrective action to improve the example data throughput for the associated network resource, or information may be automatically reported to the services provider 102 which may take corrective action. For example, if based on collected and analyzed telemetry data it is determined that a given network resource (e.g., the example VPN interface) always become over utilized with data traffic on particular days of the week at particular times, the user and or services provider may request that the example VPN interface be supplemented or re-routed during the days and times when data traffic overloads the currently provisioned VPN interface.

According to examples, stored, aggregated and/or analyzed telemetry data may be passed to the artificial intelligence/machine learning (AI/ML) model 136. According to examples, a services provider 102 and/or a user 140, 142 may utilize machine learning and artificial intelligence techniques for predicting appropriate use of network resources. That is, when network resources of the network 100 are being set up and provisioned for a user 140, 142, the AI/ML model may be queried by the services provider 102 and/or user 140, 142 to receive predictive planning information on how network resources and associated router resource objects 120-128 should be provisioned and implemented. According to one example, the AI/ML model 136 may operate via one or more known systems such as use of large language models for performing predictive functions. As known by those skilled in the art, large language models (LLM) are trained with vast amounts of text, data and statistical data representing relationships between and among text and data items. Thus, querying such systems allows for generation of predictions associated with a given text or data item.

With respect to the present disclosure, after training the AI/ML model 136 with stored, aggregated and analyzed telemetry or event log data, as described herein, future provisioning of the router 116 with network resources and associated router resource objects may be performed with predictive planning information from the AI/ML model 136. For example, a services provider 102 may query the AI/ML model 136 for setup provisioning information for a given network resource, such as the example VPN interface described above. The query to the AI/ML model 136 may include user-defined objectives, requirements, and intents such as data routing, data transport requirements, etc. Based on the query, the AI/ML model 136 may return a predicted data routing path that may meet the user-defined objectives, requirements, and intents. For example, the returned predicted path may prescribe that data for the user should pass through data transport systems in New York, then to Atlanta, then to Dallas, and then to a destination in Los Angeles. Such an example predicted path would be based on training provided to the AI/ML model that would cause data to travel from the example starting point of New York and terminate at the example endpoint of Los Angeles in a manner that meets the user-defined operation of the desired network resource and associated data transport objectives, requirements and intents.

As described above, if router resource objects 120-128 provisioned on the router 116 for a number of network resources are associated with multiple users 140, 142, the process of separating telemetry data from the router 116 for the network resources and associated router resource objects 120-128 is computationally difficult and expensive. That is, if telemetry from the router 116 for a given network resource and associated router resource object 120 that is associated two or more users 140, 142, the telemetry will be associated with the performance of the given network resource and associated router resource object as opposed to being associated with the performance of the given network resource on a user-by-user basis. For example, if two users 140, 142 require data transport throughput through the network 100 via a VPN interface, telemetry for the example VPN interface may include the overall or total data transport throughput for the interface, and determining the data transport throughput for each of the two users is difficult to determine. Thus, by separating telemetry for the example VPN interface on a network resource identity basis (e.g., user-by-user basis), the telemetry for each example user may be aggregated, analyzed, and reported to each example user or to a services provider for the example VPN interface separately from telemetry for other users.

Referring still to FIG. 1, according to examples, provisioning of metadata on the router resource objects of the network router associated with various network resources allows events associated with the network resources to be stored as event logs on a network resource identity basis for analysis, reporting, and possible corrective action. For example, if a communications interface (e.g., the above-mentioned VPN interface) operated via the router fails, an alarm or notification for the failure may be stored as an event log for analysis, reporting, and possible corrective action. If metadata identifying a user or other network resource identity associated with the failing communications interface is provisioned on the router, then an event log associated with the failing communication may be generated, and the metadata associated with the user or other network resource identity in association with the failing communications interface allows for the event to be managed in association with the user or other network resource identity. That is, knowing event data associated with a given network resource identity (e.g., a user) allows for management of network resources in association with the network resource identity (e.g., assuring service level agreements for the example user).

As illustrated in FIG. 1, in addition to telemetry streamed to the telemetry collector 132, events logs generated at the router 116 in association with network resources events may be passed directly to a system log (syslog) server 138. Generation and storage of event logs is well known to those skilled in the art. Based on provisioning the router resource objects 120-128 of the router 116 as described above, event logs generated for network resources associated with the router resource objects 120-128 may be identified on a network identity basis in the same manner as identified for telemetry discussed above. For example, if the example VPN interface is associated with two or more users, failure or other problems with the example VPN interface may cause an event log to be generated and sent to the syslog server 138 for future analysis and reporting. According to examples, metadata provisioned on the router resource objects 120-128 allows for application by the router 116 of metadata to the event logs on a network resource identity basis (e.g., user-by-user basis). Thus, an event log for failure of the example VPN interface for a first user may be separated from an event log for failure of the example VPN interface for a second user. By separating the event logs on a network resource identity basis, all event logs for a particular network resource identity (e.g., user-based, location-based, service-based, etc.) may be aggregated, analyzed, and reported. For example, all event logs associated with various network resources utilized by a particular user may be aggregated and reported to the particular user and/or to services providers of the various network resources. As illustrated in FIG. 1, event logs from the syslog server 138 may be passed to the analytics engine 134, the AI/ML model 136 and/or to the users 140, 142 for the same purposes and in the same manner as telemetry discussed above. Referring still to FIG. 1, event logs may be passed to the telemetry collector 132 for separation and aggregation on a network resource identity basis (e.g., user-based, location-based, service-based, etc.). After separation and aggregation at telemetry collector 132, event logs data may be passed to the syslog server 138, as described above, or event logs data may be passed to the analytics engine 134, the AI/ML model 136 and/or to the users 140, 142 for the same purposes and in the same manner as telemetry discussed above.

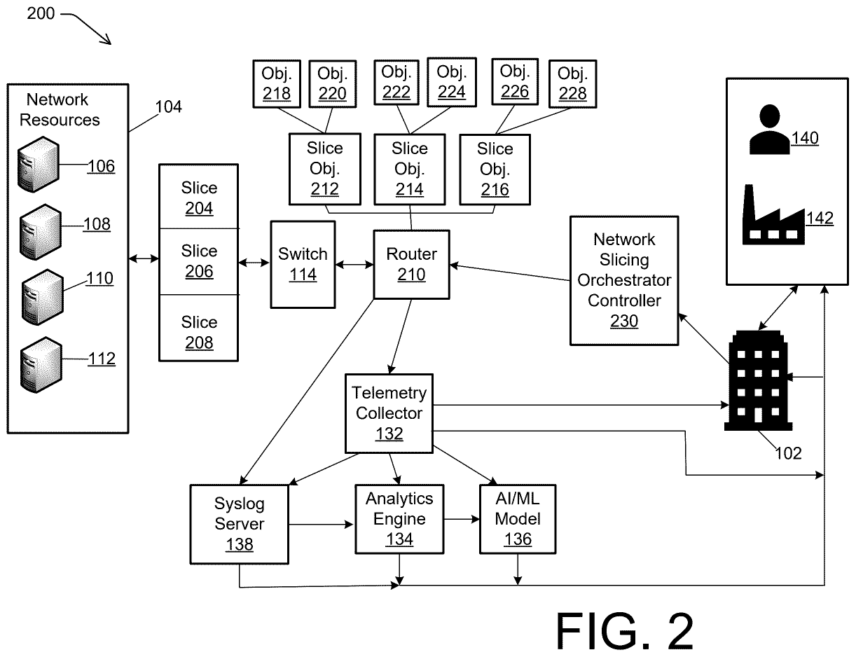

FIG. 2 illustrates a system architecture for applying contextual metadata to router resource objects in a sliced data network for identifying telemetry and event logs on a resource identity basis from a telemetry feed or events log. According to examples, the network 200 illustrated in FIG. 2 represents a network slicing configuration. In contrast to the network 100 illustrated in FIG. 1, the network 200 illustrated in FIG. 2 provides for hosting of network services in virtual slices or partitions of network computing and communications systems and devices 104-112. As understood by those skilled in the art, evolving generations of telecommunications and data transport systems have defined network slicing where the user requests a specific transport service objective or outcome required to be provided by the network 100 (e.g., ultra-reliable low latency (URLLC), enhanced mobile broadband (eMBB)) for high bandwidth services, and the like) with the expectation that services provider 102 can satisfy the user's objective via an abstracted network slice 204-208 via an application programming interface (API) request to a network slicing orchestrator controller 230.

The benefits of transport slicing are self-evident, since a single network can be divided to cover diverse use cases based on user demand and segmentation. Network operators can then allocate resources to each slice service, utilizing the necessary speed, throughput, and data transport latency to cover the breadth of network slicing applications required by users 140, 142. As described herein, an important piece of such a network slicing system is that the service be properly monitored to ensure the user objectives and intent (e.g., data throughput) are being met. Monitoring requires both active service assurance (probing) and passive service assurance (packet counters, queue drops, route population, interface errors, etc.).

According to a network slicing configuration, network slices (e.g., virtual slices or partitions) 208 204, 206, 208 of the computing and communications systems and devices 104-112 are configured for hosting the network operations of each user. That is, each network slice 204, 206, 208 serves as a virtual instantiation of the network computing and communications systems and devices 104-112. From a user perspective, a network slice 204, 206, 208 provides the user functionality of the network 200 as if the user is the only user of the network 200. For example, referring still to FIG. 2, a first user 140 may be assigned to network slice 204, a second user 142 may be assigned to network slice 206, and a third or more users may be assigned to additional network slices 208, and so on. As should be appreciated, the number of network slices available via network 200 are limited only by available computing and communications resources (e.g., data transport speeds, data transport latency, data transport bandwidth, data packet loss levels, data throughput, data transport security information, and the like).

Referring still to FIG. 2, a network slicing orchestrator controller 230 is responsible for configuration of each slice for corresponding user network requests. According to examples, the network slicing orchestrator controller 230 provisions network slice objects 212, 214, 216 for each network slice 204, 206, 208 on the router 210 to direct the router to 210 on how data transport to and from each network slice 204, 206, 208 is to be handled for each user 140, 142 (e.g., use of one or more router resource objects, described herein). For each network slice, network slice objects 212, 214, 216, router resource objects 218, 220, 222, 224, 226, 228 associated with network resources operated via the router 210 for users of the network slices 204, 206, 208 are provisioned on the router 210 in the same manner as router resource objects 120-128 are provisioned on the router 116 described above with reference to FIG. 1. As described above with reference to FIG. 1, according to examples, the systems, methods described herein operating via the router 210 may be operated via the switch 114 or similar network device or system. Similarly, the one or more router resource objects 218, 220, 222, 224, 226, 228 may also be provisioned on a switch 114 for performing the functions of the router resource objects as described herein. According to one example, the functionality of the router 210 and the switch 114 may operate via a single network device that includes the functionality of both the switch 114 and the router 210.

As described above with reference to FIG. 1, during operation of the network 200, telemetry associated with operation of the network slices 204, 206, 208 for associated users 140, 142 is passed from the router 210 in association with router resource objects and various network resources provided through the router 210 to the telemetry collector 132. At the telemetry collector 132, telemetry information may be stored, separated and aggregated on a network resources identity basis (e.g., user-by-user, location-by-location, service-by-service basis, etc.) so that aggregated telemetry information for each network resource identity may be passed to the analytics engine 134 for analysis and to the AI/ML model 136 for training the AI/ML model 136. In addition, the telemetry information may be passed directly to users 140, 142 and/or the services provider 102 for the network 200 for review and maintenance of the network 200.

Referring still to FIG. 2, in addition to telemetry streamed to the telemetry collector 132, events log generated at the router 210 in association with network resources events may be passed directly to a syslog server 138 or to the telemetry collector 132 in the same manner as described above for event logs with reference to FIG. 1. After separation and aggregation of event logs data on a network resource basis at either the syslog server 138 or the telemetry collector 132, as described above, event logs data may be passed to the analytics engine 134 and/or to the AI/ML model 136 and then on to the users 140, 142 and/or to a services provider 102 as described herein.

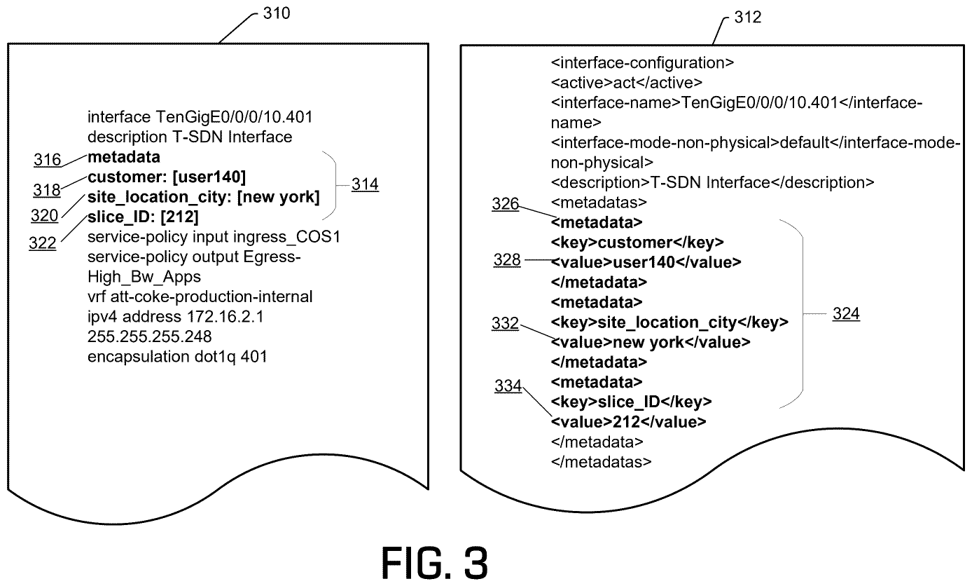

FIG. 3 illustrates a pair of example metadata tagging programming formats for configuration of example router resource objects associated with one or more network resources as described herein. As appreciated by those skilled in the art, programming used to configure resource router resource objects 120-128 (FIG. 1) and 218-228 (FIG. 2) may be prepared according to a number of programming languages. For purposes of examples, the programming code excerpts illustrated and described with reference to FIG. 3 are for programming a router resource object associated with a virtual routing and forwarding (VRF) interface. As should also be appreciated, the programming code layout (including carriage returns, indentions, and boldfacing) illustrated in FIG. 3 is for purposes of example only and is not intended to represent programming code specific to a given programming code language.

Referring still to FIG. 3, a programming code excerpt 310 is illustrative of a portion of programming code used by the network orchestrator controller 118 or network slicing orchestrator controller 230 to provide contextual metadata to configuration programming of a given router resource object. The programming code excerpt 310 is illustrated according to a command line interface (CLI) format with which text-based command lines may be used by the network orchestrator controller 118 or network slicing orchestrator controller 230 to configure one or more router resource objects 120-128, 218-228 as described herein. As illustrated in the programming code excerpt 310, text-based command lines are shown that are used for programming contextual metadata in addition to other command lines to configure a given router resource object. According to examples of the present disclosure, a number of lines of contextual metadata 314 (illustrated in boldface for emphasis) are included with which the telemetry collector 132 and/or syslog server 138 may separate telemetry on a network resource identity basis as described herein.

Referring to the contextual metadata lines, the string “metadata” 316 is included to denote a beginning of the contextual metadata text. A customer line 318 is included in which is identified a user identified as user 140. As described above, the user 140 may be illustrative of an individual user (e.g., John Doe) or a small to large scale entity (e.g., ABC, Inc.). The customer line identifying the user 140 may include any acceptable identifying text for the user 140. According to examples, the same customer line text will be used in command line programming for all resource objects 120-128, 218-228 so that telemetry from associated router resource objects may be easily separated at the telemetry collector 132 and/or syslog server 138 and may be aggregated by network resource identity. For example, all telemetry and/or event logs for the user 140 may be separated from telemetry and/or event logs associated with other users.

Referring still to the contextual metadata 314 in the programming code excerpt 310, a site location command line 320 may be included. In the example, the site location command line 320 identifies an example location of “New York.” As should be appreciated, a given user, for example, a large business with multiple operating locations may want telemetry on a location basis as opposed to or in addition to telemetry on a user basis. Alternatively, a given user may want telemetry on both a user and location basis. As should be appreciated, other types of contextual metadata, for example, facility location, building location, and the like may be included to allow additional identification of telemetry and/or event logs on a more granular level, for example, telemetry on a building-by-building basis for an organization that utilizes network resources on a building-by-building configuration.

A slice identification (ID) command line 322 is illustrated for identifying a network slice in which a given user's network services are configured, as described above with reference to FIG. 2. As should be appreciated, the slice ID command line 322 allows for telemetry and/or event logs to be further identified when a given user's network resources are configured in a given network slice 204-208 (FIG. 2). If the user's network resources are not configured in a network slicing configuration, as illustrated in FIG. 2, the slice ID command line 322 may be omitted or may be left blank.

Referring still to FIG. 3, a programming code excerpt 312 is illustrative of another portion of programming code used by the network orchestrator controller 118 or network slicing orchestrator controller 230 to provide contextual metadata to configuration programming of a given router resource object for an associated network resource. The programming code illustrated in the programming code excerpt 312 is formatted according to the extensible markup language (XML). As with the programming code excerpt 310, contextual metadata 324 (illustrated in boldface for emphasis) are used for providing contextual metadata in addition to other command lines to configure a given router resource object. The contextual metadata 324 are included with which the telemetry collector 132 and/or syslog server will separate telemetry and/or event logs on a network resource identity basis as described herein.

As with the programming code excerpt 310, described above, the string “metadata” 326 is included to denote a beginning of the contextual metadata text. A customer line 328 is included in which is identified a user identified as user 140. A site location command line 332 is included in which is identified an example location of “New York.” A network slice identification command line 334 is illustrated for identifying a network slice of 212 in which a given user's network services are configured, as described above with reference to FIG. 2. As should be appreciated, while the programming code excerpts illustrated in FIG. 3 show CLI and XML formatting for an example VRF interface, similar programming coded may be provided according to other formatting languages and for other network resources, as described herein.

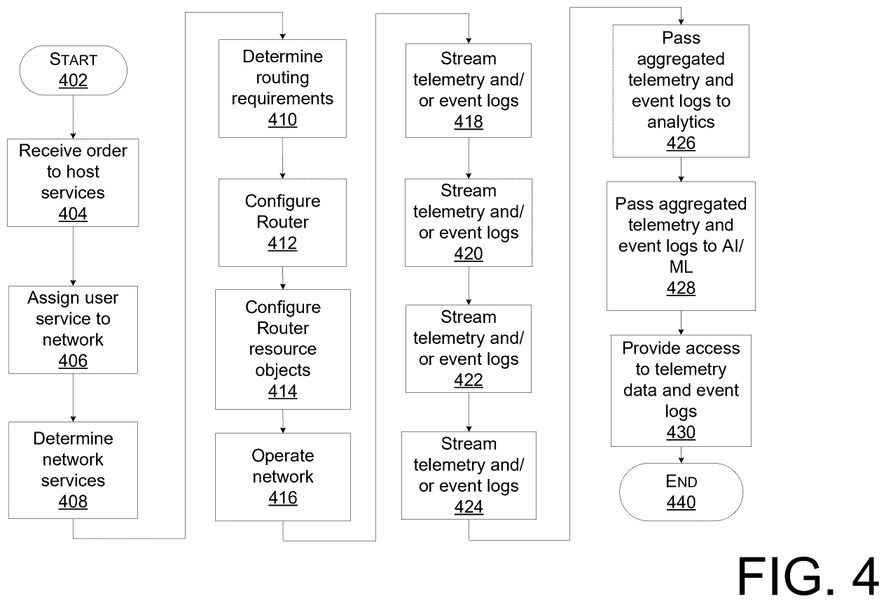

FIG. 4 illustrates a flow diagram of an example method for configuring a router resource object with metadata that may be used for identifying telemetry and/or event logs associated with a particular network resource identity. The method 400 begins at start operation 402 and proceeds to operation 404 where an order to host user services is received by a services provider 102 (e.g., a telecommunications or Internet services provider). For example, an individual user or small to large entity user may contract with a services provider 102 to provide network services as described herein. According to examples, the user may have a service level agreement (SLA) with the services provider 102 to provide network resources for one or more services for which one or more resource router resource objects will need to be provisioned for the user 140, 142. At operation 406, the services provider 102 assigns the user to a network 100, 200 for provision of requested services. According to examples, the user's requested network resources may be provisioned on a network system such as illustrated in FIG. 1. Alternatively, users requested network services may be provisioned via a network slice as illustrated and described above with reference to FIG. 2.

At operation 408, the services provider 102 determines network resources required for provisioning services to the user. At operation 410, the services provider 102 determines routing requirements for the requesting user. According to examples, routing requirements for the requesting user may include a determination of one or more network resources (e.g., communications interfaces of various types) necessary for communication with computing and/or communications devices or systems 104-112 and/or a slice 204-208 of a network slicing network.

At operation 412, the network orchestrator controller 118 or the network slicing orchestrator controller 230 configures the router 116, 210 with one or more router resource objects 120-128, 218-228 required for managing network resources via one or more router resource objects to one or more network computing and/or communications systems or devices (network resources) 104-112 through the router 116, 210 via the network 100, 200.

At operation 414, the network orchestrator controller 118 or the network slicing orchestrator controller 230 configures each router resource object with contextual metadata 314, 324 as described above with reference to FIG. 3. As described herein, the contextual metadata 314, 324 will allow the telemetry collector 132 and/or the syslog server 138 to separate telemetry and/or event logs based on network resource identifying information provided in the contextual metadata 314, 324.

At operation 416, the computing and/or communications devices or systems 104-112 are operated and communicate via one or more network resources (e.g., communications interfaces) through the router 116, 210 in accordance with the provisioned router resource objects. At operation 418, telemetry data for one or more network resources hosted by the services provider 102 according to provisioned router resource objects is generated and streamed as a telemetry feed via the router 116, 210 to the telemetry collector 132. The telemetry feed generated from the network router 116, 210 may include the contextual metadata and one or more attributes of the network resources. In addition, at operation 418, any event logs generated for the operating computing and/or communications devices or systems 104-112 are passed to the syslog server 138 and/or to the telemetry collector 132, as described above with reference to FIGS. 1 and 2. At operation 420, telemetry and/or event logs passed to the telemetry collector 132 is/are received and stored, and event logs passed to the syslog server 138 are received and stored.

At operation 422, the telemetry collector 132 parses the contextual metadata 314, 324 received for telemetry data and/or event logs. Based on identifying information included in the contextual metadata 314, 324, the telemetry collector 132 separates telemetry data on one or more identification criteria, for example, particular users, user locations, network services, network services locations, network routing protocols, network security protocols, Internet Protocol (IP) addresses associated with network resources, communications interfaces, and the like, as described above with reference to FIG. 3. Likewise, at operation 424, the syslog server 138 separates event logs based on identifying information included in contextual metadata 314, 324. At operation 424, separated telemetry and/or event logs is/are aggregated according to the contextual metadata. For example, the telemetry data and/or event logs may be aggregated based associated network resource identities described herein.

At operation 426, the aggregated telemetry data and/or event logs, including the one or more attributes of the network resources for each network resource identity may be stored and may be passed to the analytics engine 134 for analysis. For example, for each network resource for which telemetry data and/or event logs is/are received, the analytics engine 134 may determine data transport speeds, data transport latency, data transport bandwidth, data packet loss levels, data throughput, data transport security information, and the like. That is, performance data for any network resource provided for a given network resource identity may be analyzed to determine if the performance of the network resource meets or exceeds the requirements as requested or as agreed upon between the user 140, 142 and the services provider 102. Event logs data for any network resource may be analyzed to determine causes of associated events, potential corrective action available for associated events and/or for reporting to a user 140, 142 or services provider 102.

At operation 428, aggregated telemetry data and/or event logs may be passed to the AI/ML model 136. The telemetry data and/or event logs passed to the AI/ML model 136 may be used to train the AI/ML model 136 for subsequent use by user 140, 142 and or services provider 102 for providing predicted network configurations and/or network corrective actions for one or more components or resources of the network 100, 200.

At operation 430, aggregated telemetry data and/or event logs, analyzed telemetry data and/or event logs, and/or information from the AI/ML model 136 may be provided to a requesting user or services provider. For example, a requesting user or services provider may utilize telemetry data and/or event logs, analyzed telemetry data and/or event logs and/or information from the AI/ML model 136 for ensuring required network service levels are being met and for informing a requesting user or services provider for future network provisioning. The method 400 ends at operation 440.

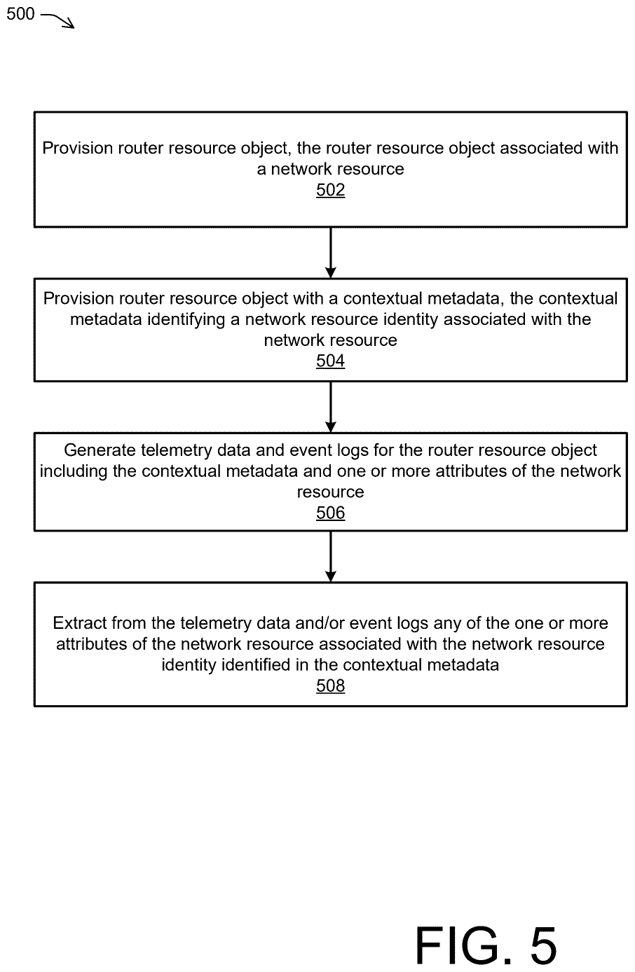

FIG. 5 illustrates a flow diagram of an example method for identifying network resource identity-specific telemetry and/or event logs from a network telemetry feed. The method 500 begins at operation 502 where a router resource object is provisioned, the router resource object associated with a network resource. At operation 504, the router resource object may be provisioned with a contextual metadata, the contextual metadata identifying a network resource identity associated with the network resource. Provisioning the router resource object with a contextual metadata may also include provisioning the router resource object with a contextual metadata identifying other network resource identities associated with the network resource, and identifying a virtual network slice to which the network resource is associated if the network is configured for network slicing.

At operation 506, telemetry is generated for the network resource including the contextual metadata and one or more attributes of the network resource. At operation 508, any of the one or more attributes of the network resource associated with the network resource identity identified in the contextual metadata are extracted from the telemetry. Prior to extracting the one or more attributes of the network resource, the telemetry is parsed, and the contextual metadata is read. The one or more attributes of the network resource may include one or more of data transport speeds, data transport latency, data transport bandwidth, data packet loss levels, data throughput, data transport security information, and the like.

According to examples, a syslog feed may be generated from the network router for the router resource object including the contextual metadata and one or more event logs associated with the network resource. The syslog feed may be passed to a syslog server, and at the syslog server, the one or more event logs may be extracted from the one or more attributes of the network resource associated with the network resource identity associated with the network resource.

According to examples, the one or more attributes of the network resource in association with the user identified in the contextual metadata may be stored. The stored one or more attributes of the network resource may be aggregated with one or more attributes of one or more other network resources associated with the user identified in the contextual metadata. If the contextual metadata identifies one or more other users associated with the network resource, the one or more other attributes of the network resource in association with the one or more other network resource identities associated with the network resource is stored separately from storing the one or more attributes of the network resource in association with the user identified in the contextual metadata.

The stored one or more attributes of the network resource may be passed to an analytics engine for analysis to determine, among other things, whether the one or more attributes of the network resource meet user-defined network requirements. The stored one or more attributes of the network resource also may be passed to an artificial intelligence/machine learning model to teach the model for future query processing associated with network resource operation. In addition, the stored one or more attributes of the network resource also may be passed to the user of the network resource and/or to a services provider of the network in which the network resource operates.

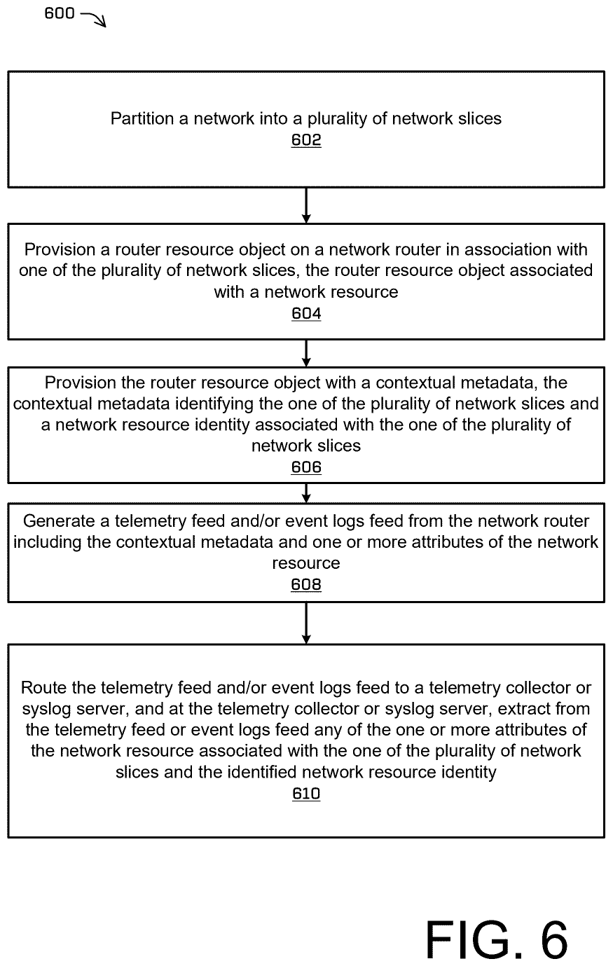

FIG. 6 illustrates a flow diagram of an example method for identifying network resource identity-specific telemetry and/or event logs from a network telemetry feed. The method 600 begins as operation 602 where a network may be partitioned into a plurality of network slices. At operation 604, a router resource object may be provisioned on a network router in association with one of the plurality of network slices, the router resource object associated with a network resource operable to communicate via the network router with one or more network resources.

At operation 606, the router resource object may be provisioned with a contextual metadata, the contextual metadata identifying the one of the plurality of network slices and a user associated with the one of the plurality of network slices. Provisioning the router resource object with a contextual metadata also may include provisioning the router resource object with a contextual metadata identifying other network resource identities associated with the network resource.

At operation 608, a telemetry feed may be generated from the network router for the network resource including the contextual metadata and one or more attributes of the network resource. At operation 610, the telemetry feed may be routed to a telemetry collector, and at the telemetry collector, any of the one or more attributes of the network resource associated with the one of the plurality of network slices and the user associated with the one of the plurality of network slices identified in the contextual metadata may be extracted from the telemetry feed. According to examples, a syslog feed may be generated from the network router for the router resource object including the contextual metadata and one or more event logs associated with the network resource. The syslog feed may be passed to a syslog server, and at the syslog server, the one or more event logs may be extracted from the one or more attributes of the network resource associated with the network resource identity associated with the network resource.

According to examples, the one or more attributes of the network resource in association with the one of the plurality of network slices and the user associated with the one of the plurality of network slices identified in the contextual metadata may be stored. The stored one or more attributes of the network resource may be aggregated with one or more attributes of one or more other network resources associated with the one of the plurality of network slices and the user associated with the one of the plurality of network slices identified in the contextual metadata. Storing the one or more attributes of the network resource also may include storing the one or more attributes of the network communications in association with the location identified in the contextual metadata.

FIG. 7 is a computer architecture diagram showing an illustrative computer hardware architecture for implementing a computing system/device that can be utilized to implement aspects of the various technologies presented herein. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a client computing systems and devices 104-112 as illustrated in FIGS. 1 and 2 and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to start up the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the networks 100, 200. The chipset 706 can include functionality for providing network connectivity through a NIC 712, such as a gigabit Ethernet adapter. The NIC 712 is capable of connecting the computer 700 to other computing devices over the network 100, 200. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the storage device 718 described above, the computer 700 can have access to other computer-readable storage media to store and retrieve information, such as program components, data structures, or other data. It should be appreciated by those skilled in the art that computer-readable storage media is any available media that provides for the non-transitory storage of data and that can be accessed by the computer 700. In some examples, the operations performed by the computing systems and devices 104-112, and or any components included therein, may be supported by one or more devices similar to computer 700. Stated otherwise, some or all of the operations performed by the computing systems and devices 104-112, and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

The computer 700 may include one or more CPUs 704 (i.e., processors) configured to execute one or more stored instructions. The CPUs 704 may comprise one or more cores. The router resource objects may include devices configured to couple to personal area networks (PANs), wired and wireless local area networks (LANs), wired and wireless wide area networks (WANs), and so forth. For example, the router resource objects may include devices compatible with Ethernet, Wi-Fi™, and so forth. The programs 722 may comprise any type of programs or processes to perform the techniques described in this disclosure for utilization of contextual metadata for identifying network operation telemetry or event log data. Such programs or processes may include programming applied to router resource objects as illustrated and described above with reference to FIG. 3

While the invention is described with respect to the specific examples, it is to be understood that the scope of the invention is not limited to these specific examples. Since other modifications and changes varied to fit operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
provisioning a router resource object on a network router, the router resource object associated with a network resource;
provisioning the router resource object with a contextual metadata, the contextual metadata identifying a network resource identity associated with the network resource;
generating telemetry data for the network resource, the telemetry data including the contextual metadata; and
extracting from the telemetry data one or more attributes of the network resource associated with the network resource identity associated with the network resource.

2. The method of claim 1, further comprising:
storing the one or more attributes of the network resource in association with the network resource identity identified in the contextual metadata.

3. The method of claim 2, further comprising:
aggregating the one or more attributes of the network resource with one or more other attributes of one or more other network resources associated with the network resource identity identified in the contextual metadata.

4. The method of claim 3, wherein in response to the contextual metadata identifying one or more other network resource identities associated with the network resource, storing the one or more attributes of the network resource in association with the one or more other network resource identities associated with the network resource separately from storing the one or more attributes of the network resource in association with the network resource identity identified in the contextual metadata.

5. The method of claim 2, further comprising:
determining whether the one or more attributes of the network resource meets a user-defined operation of the network resource; and
reporting the one or more attributes of the network resource to the network resource identity identified in the contextual metadata.

6. The method of claim 2,
wherein provisioning the router resource object with a contextual metadata includes provisioning the router resource object with a contextual metadata identifying a user associated with the network resource as the network resource identity; and
wherein storing the one or more attributes of the network resource includes storing the one or more attributes of the network resource in association with the user identified in the contextual metadata.

7. The method of claim 2,
wherein provisioning the router resource object with a contextual metadata includes provisioning the router resource object with a contextual metadata identifying a virtual network slice with which the router resource object is associated; and
wherein storing the one or more attributes of the network resource includes storing the one or more attributes of the network resource in association with the virtual network slice with which the router resource object is associated.

8. The method of claim 1, wherein the one or more attributes of the network resource includes one or more of data transport speed, data packet loss levels; data transport latency; data throughput; data transport bandwidth; and data security information.

9. The method of claim 2, wherein after storing the one or more attributes of the network resource in association with the network resource identity identified in the contextual metadata, providing the one or more attributes of the network resource to one or more of a user and a services provider of the network resource.

10. The method of claim 1, further comprising:
generating a syslog feed from the network router for the router resource object including the contextual metadata and one or more event logs associated with the network resource; and
routing the syslog feed to a syslog server, and at the syslog server, extracting from the one or more event logs one or more attributes of the network resource associated with the network resource identity associated with the network resource.

11. A method comprising:
partitioning a network into a plurality of network slices;
provisioning a router resource object on a network router in association with one of the plurality of network slices, the router resource object associated with a network resource associated with the one of the plurality of network slices;
provisioning the router resource object with a contextual metadata, the contextual metadata identifying the one of the plurality of network slices and a network resource identity associated with the network resource;
generating a telemetry feed from the network router for the router resource object including the contextual metadata and one or more attributes of the network resource; and
routing the telemetry feed to a telemetry collector, and at the telemetry collector, extracting from the telemetry feed any of the one or more attributes of the network resource associated with the one of the plurality of network slices and the network resource identity associated with the one of the plurality of network slices identified in the contextual metadata.

12. The method of claim 11, further comprising:
storing the one or more attributes of the network resource in association with the one of the plurality of network slices and the network resource identity identified in the contextual metadata; and
aggregating the one or more attributes of the network resource with one or more other attributes of one or more other network resources associated with the one of the plurality of network slices and the network resource identity identified in the contextual metadata.

13. The method of claim 12, wherein in response to the contextual metadata identifying one or more other network resource identities associated with the network resource, storing the one or more attributes of the network resource in association with the one or more other network resource identities associated with the network resource separately from storing the one or more attributes of the network resource in association with the network resource identity identified in the contextual metadata.

14. The method of claim 11, further comprising:
generating a syslog feed from the network router for the router resource object including the contextual metadata and one or more event logs associated with the network resource; and
routing the syslog feed to a syslog server, and at the syslog server, extracting from the one or more event logs any of the one or more attributes of the network resource associated with the network resource identity.

15. The method of claim 14, further comprising:
storing the one or more attributes of the network resource extracted from the one or more event logs; and
aggregating the one or more attributes of the network resource extracted from the one or more event logs with one or more other attributes of one or more other network resources extracted from one or more other event logs associated with the one of the plurality of network slices and the network resource identity identified in the contextual metadata.

16. The method of claim 11, wherein the one or more attributes of the network resource includes one or more of data transport speed, data packet loss levels; data transport latency; data throughput; data transport bandwidth; and data security information.

17. A network comprising:
a network router including at least one processor and one or more non-transitory computer-readable media storing computer-executable instructions that, when executed by the at least one processor, cause the at least one processor to perform operations comprising:
provisioning a router resource object, the router resource object associated with a network resource;
provisioning the router resource object with a contextual metadata, the contextual metadata identifying a network resource identity associated with the network resource;
generating one or more of a telemetry feed and an event log for the router resource object including the contextual metadata and one or more attributes of the network resource; and
extracting from the one or more of the telemetry feed and the event log any of the one or more attributes of the network resource associated with the network resource identity identified in the contextual metadata.

18. The network of claim 17, the at least one processor caused to perform further operations, comprising:
storing the one or more attributes of the network resource in association with the network resource identity identified in the contextual metadata; and
aggregating the one or more attributes of the network resource with one or more attributes of one or more other network resources associated with the network resource identity identified in the contextual metadata.

19. The network of claim 17,
wherein in response to the contextual metadata identifying one or more other network resource identities associated with the network resource, storing the one or more attributes of the network resource in association with the one or more other network resource identities associated with the network resource separately from storing the one or more attributes of the network resource in association with the network resource identity identified in the contextual metadata.

20. The network of claim 18, the at least one processor caused to perform further operations, comprising:
routing the one or more attributes of the network resource associated with the network resource identity identified in the contextual metadata to an artificial intelligence model; and
training the artificial intelligence model with the one or more attributes of the network resource associated with the network resource identity identified in the contextual metadata.
